(19) United States
(12) Patent Application Publication
(10) Pub. No.: US 2016/0335051 A1
(43) Pub. Date: Nov. 17, 2016

(54) SPEECH RECOGNITION DEVICE, SYSTEM AND METHOD

(71) Applicant: MITSUBISHI ELECTRIC CORPORATION, Tokyo (JP)

(72) Inventors: Masanobu OSAWA, Tokyo (JP); Yuki FURUMOTO, Tokyo (JP); Keisuke WATANABE, Tokyo (JP); Takumi TAKEI, Tokyo (JP)

(73) Assignee: MITSUBISHI ELECTRIC CORPORATION, Tokyo (JP)

(21) Appl. No.: 15/110,075

(22) PCT Filed: Feb. 21, 2014
(86) PCT No.: PCT/JP2014/054172

§ 371 Date: Jul. 6, 2016

(51) Int. Cl. G06F 3/16; G06F 3/01; G06F 3/0481; G06F 3/00; G10L 15/22; G10L 15/08

(52) U.S. Cl. CPC G06F 3/167; G10L 15/22; G10L 15/08; G06F 3/04817; G06F 3/005; G06F 3/013; G10L 2015/088

(57) ABSTRACT

According to a speech recognition device of the present invention, even in the case where there are many abutting sight-line detection areas or many overlapping portions between sight-line detection areas, as exemplified by the case where a plurality of icons (display objects) are congested on a display screen, it is possible to narrow down to thereby identify one icon (display object) efficiently using a sight line and a speech-based operation, and further to decrease false recognition, so that the user's convenience can be enhanced.

### TECHNICAL FIELD

The present invention relates to a speech recognition device, a speech recognition system and a speech recognition method, for recognizing a speech spoken by a user to thereby identify a display object that corresponds to the recognition result.

### BACKGROUND ART

Heretofore, there has been known a speech recognition device that, at the time of recognizing a speech spoken by a user to thereby identify a display object that corresponds to the recognition result, performs based on a user's sight line staying in a sight-line detection area provided on a display screen, switching into a speech recognition dictionary associated with the area in which the sight line stays (see, for example, Patent Document 1).

### CITATION LIST

### Patent Document

Patent Document 1: Japanese Patent Application Laid-open No. H08-83093

### SUMMARY OF THE INVENTION

### Problems to be Solved by the Invention

However, according to the conventional speech recognition device as in, for example, Patent Document 1, when the sight-line detection areas of a plurality of icons (display objects) are overlapping together or the sight-line detection areas are mutually abutting, there is a problem that mismatching occurs between an icon that the user wants to identify and an icon that is actually identified based on the user's sight line, so that a speech recognition dictionary corresponding to the icon that is undesired by the user becomes activated, resulting in increase of false recognition.

Further, in order to identify an icon subject to speech-based operation, for example, the user is necessary to intentionally direct the sight line to other than the overlapping portion or to a position that is nearer to a sight-line detection area of his/her desired icon but is further from the other sight-line detection area. This may result in such a case where, for example, during driving of a vehicle, the user cannot concentrate on the driving and is thus placed in danger, and thus, there is another problem that the convenience decreases when the display screen is limited in its size or when the user performs the operation while being conscious of something else.

This invention has been made to solve the problems as described above, and an object thereof is to provide a speech recognition device, a speech recognition system and a speech recognition method which can identify one icon efficiently using a sight line and a speech-based operation, even in the case where there are many abutting sight-line detection areas or many overlapping portions between sight-line detection areas as exemplified by the case where a plurality of icons (display objects) are congested on the display screen.

### Means for Solving the Problems

In order to accomplish the above object, this invention provides a speech recognition device which recognizes a speech spoken by a user to thereby identify from among a plurality of display objects displayed on a display device, one display object that corresponds to a recognition result, said speech recognition device being characterized by comprising: a controller to acquire the speech spoken by the user, thereby to recognize the acquired speech with reference to a speech recognition dictionary, and to output the recognition result; a sight line acquisition unit to acquire a sight line of the user; a group generator to combine sight-line detection areas defined respectively for the display objects, on the basis of a sight-line result acquired by the sight line acquisition unit, to thereby group together the display objects existing within a combined sight-line detection area having been combined; and an identifier to identify one display object from among the display objects grouped by the group generator on the basis of the recognition result outputted by the controller; wherein the identifier identifies one display object from among the grouped display objects, or, when the one display object cannot be identified, re-groups the narrowed-down display objects.

### Effect of the Invention

According to the speech recognition device of this invention, even in the case where there are many abutting sight-line detection areas or many overlapping portions between sight-line detection areas as exemplified by the case where a plurality of icons (display objects) are congested on the display screen, it is possible to narrow down to thereby identify one icon (display object) efficiently using the sight line and the speech-based operation, and further to decrease false recognition, so that the user's convenience can be enhanced.

### BRIEF DESCRIPTION OF THE DRAWINGS

FIG. 1 is a block diagram showing an example of a navigation device to which a speech recognition device and a speech recognition system according to Embodiment 1 are applied.

FIG. 2 is a diagram showing an example of a display object (icon) displayed on a display and a sight-line detection area therefor.

FIG. 3 is tables each showing an example of detailed information of a display object (icon).

FIG. 4 is diagrams each showing another example of display objects (icons) displayed on a display and sight-line detection areas therefor, which is illustration diagrams about how to group display objects.

FIG. 5 is a flowchart showing processing for grouping display objects, generating a speech recognition dictionary corresponding to the grouped display objects, and activating the speech recognition dictionary, in Embodiment 1.

FIG. 6 is a flowchart showing processing for identifying one display object from among the grouped display objects using a speech-based operation, in Embodiment 1.

FIG. 7 is a diagram showing another example of a display object (icon) displayed on a display and a sight-line detection area therefor.

FIG. 8 is a block diagram showing an example of a navigation device to which a speech recognition device and a speech recognition system according to Embodiment 2 are applied.

FIG. 9 is a flowchart showing processing for grouping display objects, generating a speech recognition dictionary corresponding to the grouped display objects, and activating the speech recognition dictionary, in Embodiment 2.

FIG. 10 is a flowchart showing processing of identifying one display object from among the grouped display objects using a speech-based operation, in Embodiment 2.

FIG. 11 is tables each showing an example of correspondence between a recognition-result character string and a recognition score.

FIG. 12 is a block diagram showing an example of a navigation device to which a speech recognition device and a speech recognition system according to Embodiment 3 are applied.

FIG. 13 is a flowchart showing processing for grouping display objects, generating a speech recognition dictionary corresponding to the grouped display objects, and activating the speech recognition dictionary, in Embodiment 3.

FIG. 14 is a flowchart showing processing for identifying one display object from among the grouped display objects using a speech-based operation, in Embodiment 3.

### MODES FOR CARRYING OUT THE INVENTION

Hereinafter, embodiments of the invention will be described in detail while referring to the drawings.

Note that in the following embodiments, description will be made citing, as examples, cases where a speech recognition device and a speech recognition system according to this invention are applied to a navigation device or navigation system for a moving object such as a vehicle; however, they may be applied to any type of device or system if it is such a device or system that allows selecting a display object displayed on a display, etc. to thereby give an instruction for operation.

### Embodiment 1

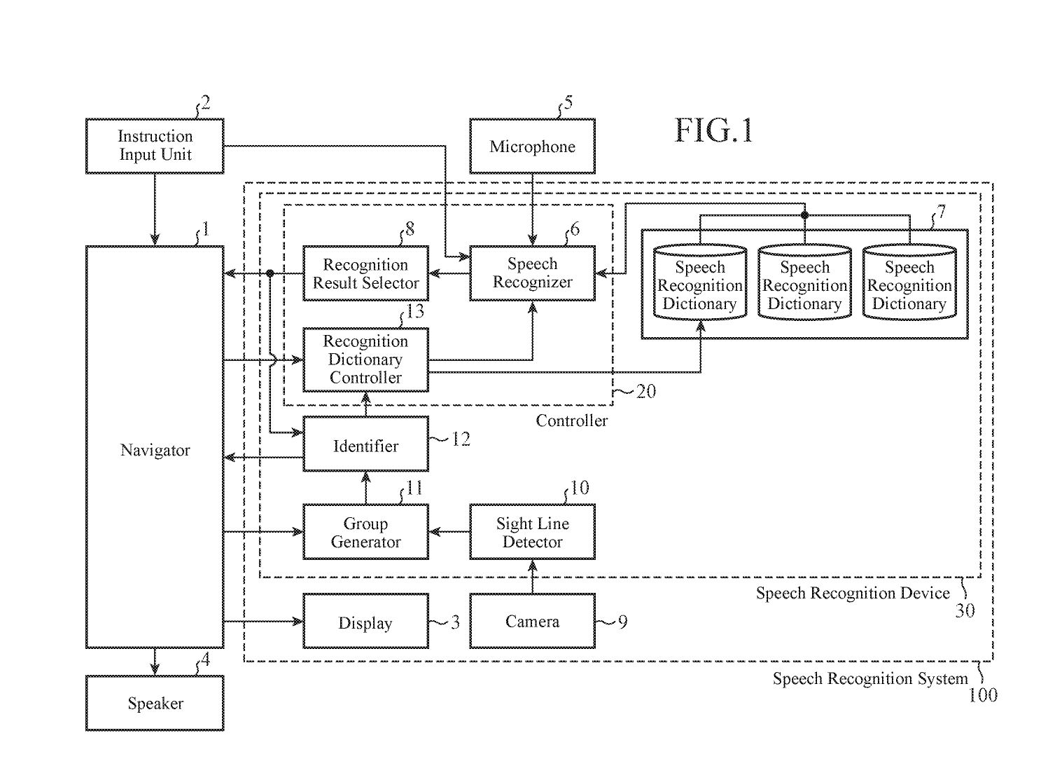

FIG. 1 is a block diagram showing an example of a navigation device to which a speech recognition device and a speech recognition system according to Embodiment 1 of the invention are applied. This navigation device includes a navigator 1, an instruction input unit 2, a display (display device) 3, a speaker 4, a microphone 5, a speech recognizer 6, a speech recognition dictionary 7, a recognition result selector 8, a camera 9, a sight line detector 10, a group generator 11, an identifier 12 and a recognition dictionary controller 13.

Note that the speech recognizer 6, the recognition result selector 8 and the recognition dictionary controller 13 constitute a controller 20, and that the controller 20, the speech recognition dictionary 7, the sight line detector 10, the group generator 11 and the identifier 12 constitute a speech recognition device 30. Further, the speech recognition device 30, the display (display device) 3 and the camera 9 constitute a speech recognition system 100.

The navigator 1 uses current-position information of a moving object acquired from a GPS receiver, etc., and information stored in a map database, to thereby generate picture information to be displayed on the display (display device) 3 which will be described later. In the map database, there are included, for example, “road information” related to roads, “facility information” (types, names, locations, etc.) related to facilities, “various pieces of character information” (place names, facility names, intersection names, road names, etc.), “various pieces of icon information” each indicative of a facility, a road number, etc., and the like.

Meanwhile, according to the instruction input unit 2 and a speech-based operation, the navigator uses information about a facility or point set by a user, about a current position of the moving object, about the map database, and the like, to thereby calculate a route from the current position to the facility, etc. set by the user. Further, the navigator generates an induction guide map or an induction guide message for guiding the moving object along that route, and outputs instructions to the display (display device) 3 and the speaker 4 for causing them to output the thus-generated information.

Further, according likewise to the instruction input unit 2 and a speech-based operation, the navigator executes a function corresponding to the content indicated by the user. For example, it searches a facility or an address, selects a display object such as an icon, a button, etc. displayed on the display (display device) 3, and/or executes a function associated with the display object.

The instruction input unit 2 serves to input an instruction given by a manual operation of the user. Examples thereof include, for example, a hardware switch provided in the navigation device, a touch sensor incorporated in the display (display device) 3, a recognition device that recognizes the instruction given through a remote controller mounted on a steering wheel of the vehicle or a separate remote controller, and the like.

The display (display device) 3 is, for example, an LCD (Liquid Crystal Display), an HUD (Head-Up Display), an instrument panel, or the like, and may be that in which a touch sensor is incorporated. The display draws a picture on its screen based on an instruction given by the navigator 1. Also, the speaker 4 outputs a sound based on an instruction given by the navigator 1.

The microphone 5 acquires a speech (collects sounds) spoken by the user. Examples of the microphone 5 include, for example, an omnidirectional microphone, an array microphone in which a plurality of omnidirectional microphones are arranged in an array so that the directional characteristic is made adjustable, a unidirectional microphone having a directional characteristic only in one direction so that the directional characteristic is not adjustable, and the like.

The speech recognizer 6 imports the user's speech acquired by the microphone 5, that is, the inputted sound, to thereby A/D (Analog/Digital) convert it using a PCM (Pulse Code Modulation), for example, and detects from the thus-digitized sound signal, a speech section corresponding to the content spoken by the user, and then, extracts feature amounts of speech data in the speech section.

Thereafter, the speech recognizer refers to the speech recognition dictionary 7 activated by the recognition dictionary controller 13, to thereby perform recognition processing for the extracted feature amounts and then to output a recognition result. Here, in the recognition result, there are included, at least, a word or word string (hereinafter, a recognition-result character string) or identification information, such as an ID, being associated with the recognition-result character string, and a recognition score indicative of its likelihood. Note that the recognition processing may be performed using a usual method, for example, a HMM (Hidden Markov Model) method, so that its description is omitted here.

Here, in Embodiment 1, description will be made assuming that a button for instructing the speech recognizer 6 to start speech recognition (hereinafter, mentioned as a speech-recognition-start instruction part) is provided on the instruction input unit 2, so that when the speech-recognition-start instruction part is pressed down by the user, the speech recognizer 6 starts recognition processing for the user's speech inputted through the microphone 5.

Note that the speech recognizer 6 may constantly perform recognition processing even without the instruction to start the speech recognition (The same also applies to the following embodiments).

The speech recognition dictionary 7 is to be used in the speech recognition processing by the speech recognizer 6, in which stored are terms each given as a speech recognition target. As the speech recognition dictionary 7, there are of a type that is prepared beforehand and a type that is dynamically generated if needed during operation of the navigation device.

Examples thereof include, for example, a speech recognition dictionary that is used for facility name recognition and is prepared beforehand from map information, etc.; and as described later, in the case where display objects of plural types are present in the display objects grouped by the group generator 11 or the display objects re-grouped by the identifier 12, a speech recognition dictionary that includes recognition target terms for identifying the types of those display objects; in the case where display objects are present in a plural number but as being of a single type therein, a speech recognition dictionary that includes recognition target terms each for identifying one display object; a speech recognition dictionary that includes recognition target terms each for identifying one display object from among the grouped display objects or the re-grouped display objects; in the case where the number of the grouped display objects or the re-grouped display objects is equal to or more than a predetermined number, a speech recognition dictionary that includes a recognition target term for deleting the display objects equal to or more than the predetermined number; and the like.

The recognition result selector 8 selects from among the recognition-result character strings outputted by the speech recognizer 6, a recognition-result character string that satisfies a predetermined given condition. In Embodiment 1, description will be made assuming that the recognition result selector 8 selects one recognition-result character string whose recognition score is highest and is a predetermined value or more (or more than a predetermined value) (The same also applies to the following embodiments).

Note that that condition is not limitative, and though depending on vocabularies given as recognition targets or on a function under execution by the navigation device, plural recognition-result character strings may be selected. For example, high ranking N pieces of recognition-result character strings with high recognition scores may be selected from among recognition-result character strings each having a recognition score of a predetermined numeric value or more (or more than a predetermined numeric value), or recognition-result character strings outputted from the speech recognizer 6 may be all selected or likewise.

The camera 9 is that which captures and acquires an eye image of the user, such as an infrared camera, a CCD camera, or the like.

The sight line detector 10 analyzes the image acquired by the camera 9 to detect a sight line of the user directed to the display (display device) 3, to thereby calculate a position of the sight line on the display (display device) 3. Note that, as each of a method of detecting the sight line and a method of calculating the position of the sight line on the display (display device) 3, a publicly known technique may be used, so that their description is omitted here.

The group generator 11 acquires information related to the display objects displayed on the display (display device) 3 from the navigator 1. Specifically, it acquires information, such as, position information of the display objects on the display (display device) 3 and information of details of the display objects.

Then, for each of the display objects displayed on the display (display device) 3, the group generator 11 sets a specific area enclosing the display object as a sight-line detection area, on the basis of displayed positions of the display objects acquired from the navigator 1. In Embodiment 1, a circle with a predetermined radius from the center of the display object is assumed as the sight-line detection area; however, this is not limitative and, for example, the sight-line detection area may be polygonal or likewise. Note that the sight-line detection area may be different for each of the display objects (The same also applies to the following embodiments).

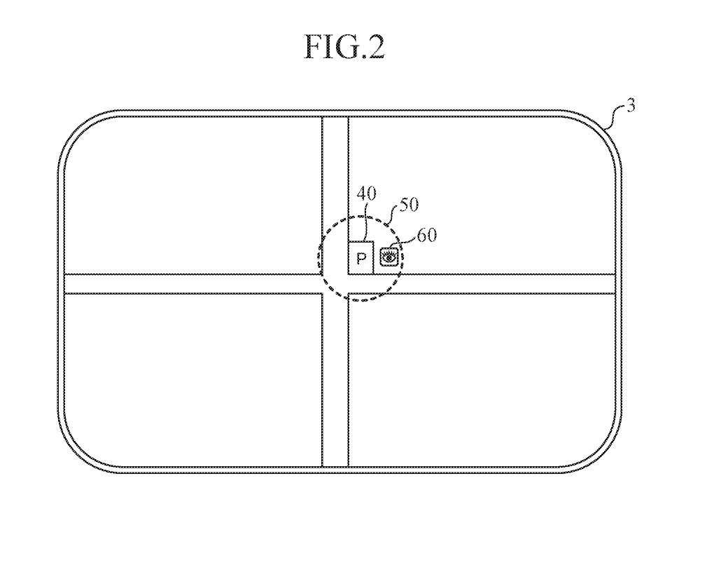

FIG. 2 is a diagram showing an example of a display object displayed on the display (display device) 3 and a sight-line detection area therefor. Here, an icon 40 is the display object and an area 50 surrounded by a broken line represents the sight-line detection area.

Note that the icon 40 shown in FIG. 2 is an icon indicative of a parking place displayed on a map screen. In Embodiment 1, description will be made about the display object citing a case where it is an icon indicative of a facility displayed on the map screen; however, the display object may be of any type so far as being selectable by the user by way of a button, etc., so that it is not limited to a facility icon (The same also applies to the following embodiments).

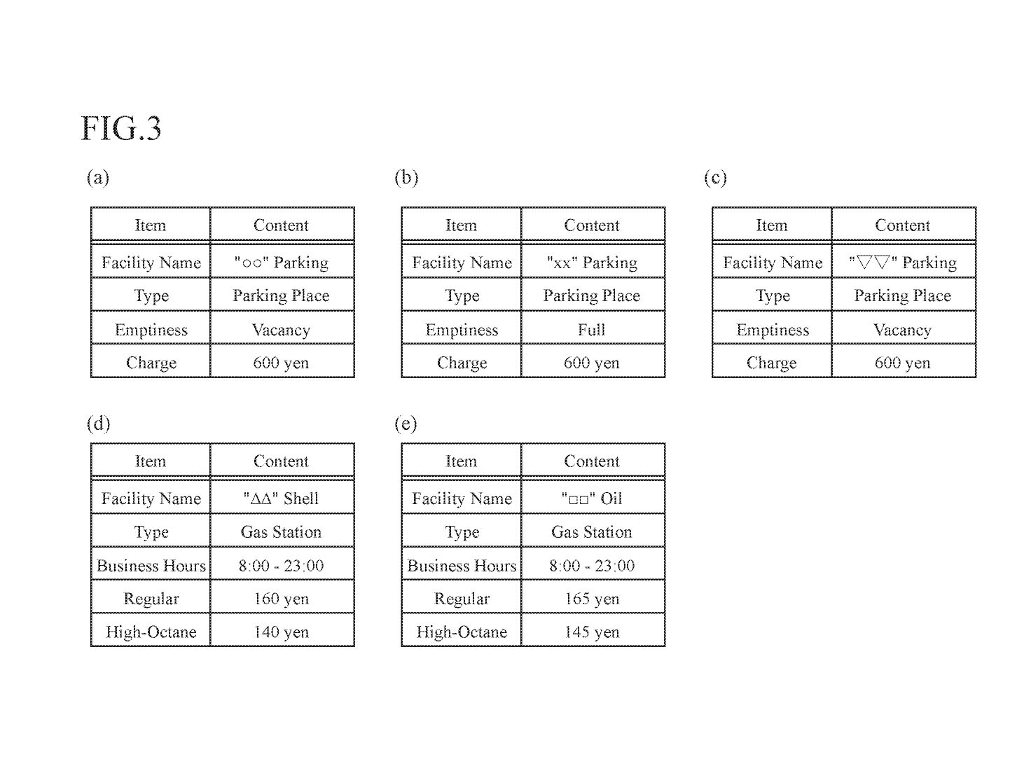

FIG. 3 is tables each showing an example of detailed information of the display object (icon). For each of parking-place icons, as detailed information, items of “facility name”, “type”, “emptiness” and “charge” are set and contents thereof as shown in FIG. 3(a) to (c) are stored, for example. Further, for each of gas-station icons, as detailed information, items of “facility name”, “type”, “business hours”, “regular” and “high-octane” are set, and contents thereof as shown in FIG. 3(d) to (e) are stored, for example.

Note that the items in the detailed information are not limited to these, and it is allowable to make addition or deletion of any item.

Furthermore, the group generator 11 acquires the position of the user's sight line from the sight line detector 10 to thereby make grouping of display objects using that information of the sight line position and the information of the sight-line detection area set for each of the display objects. Namely, when a plurality of display objects (icons) are displayed on the display screen of the display (display device) 3, the group generator 11 makes grouping after determining which display objects (icons) are to be collected as one group.

Here, the grouping of display objects by the group generator 11 will be described.

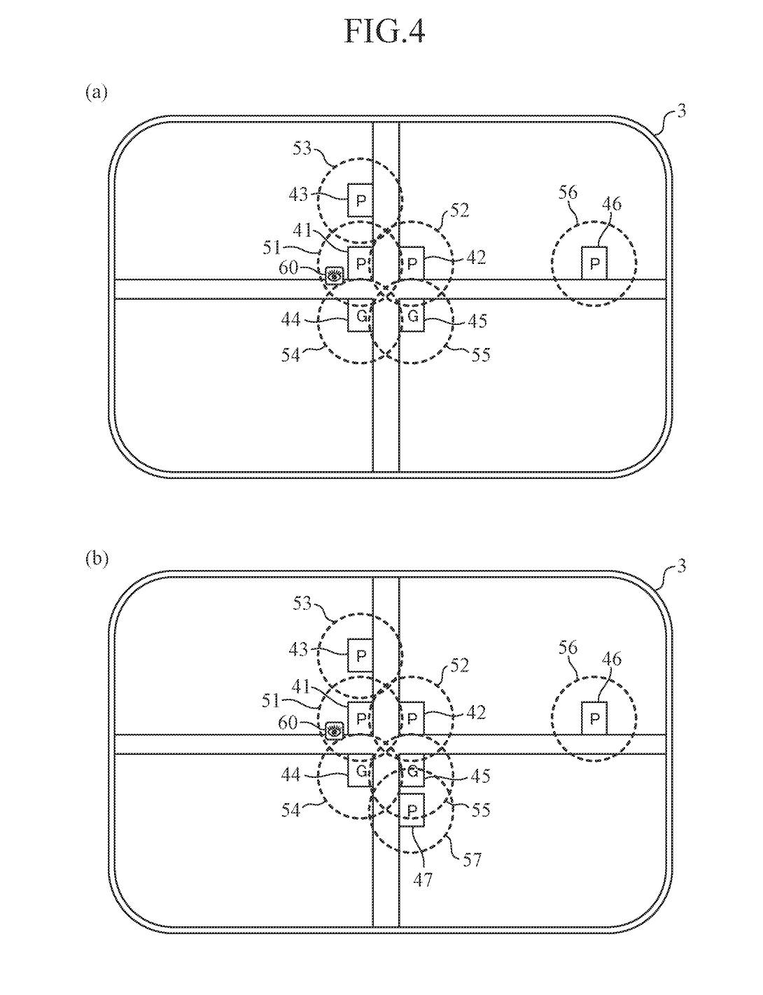

FIG. 4 is diagrams each showing another example of display objects (icons) displayed on the display (display device) 3 and sight-line detection areas therefor, which is an illustration diagram about how to group display objects.

As shown, for example, in FIG. 4(a), it is assumed that six icons 41 to 46 are displayed on the display screen of the display (display device) 3 and sight-line detection areas 51 to 56 are set for the respective icons by the group generator 11.

The group generator 11 determines each sight-line detection area in which no sight line exists (hereinafter, mentioned as “other sight-line detection area”) while at least a part of that sight-line detection area is overlapping with a sight-line detection area in which the sight line exists.

Thereafter, the group generator combines the sight-line detection area in which the sight line exists with the thus-determined other sight-line detection areas. Then, the group generator 11 groups together the display objects existing within the combined sight-line detection area into one group.

In the example in FIG. 4(a), because the sight line 60 is placed within the sight-line detection area 51 for the icon 41, the group generator 11 determines each of the sight-line detection areas 52 to 55, that is overlapping partly with the sight-line detection area 51, as the other sight-line detection area, and combines the sight-line detection areas 51 to 55. Then, it selects the icons 41 to 45 included in the combined sight-line detection area and groups them together.

Note that in Embodiment 1, the icons are grouped by the aforementioned method; however, this method is not limitative. For example, in determining the other sight-line detection area, such a sight-line detection area that is abutting the sight-line detection area in which the sight line exists may be determined as the other sight-line detection area.

Meanwhile, for example, as shown in FIG. 4(b), in the case where, seven icons 41 to 47 are displayed on the display screen of the display (display device) 3 and sight-line detection areas 51 to 57 are set for the respective icons by the group generator 11, because the sight line 60 is placed within the sight-line detection area 51 for the icon 41, according to the aforementioned method, the group generator 11 determines each of the sight-line detection areas 52 to 55, that is overlapping partly with the sight-line detection area 51, as the other sight-line detection area, and combines the sight-line detection areas 51 to 55. Then, it selects the icons 41 to 45 and 47 included in the combined sight-line detection area and groups them together.

In a method other than the case of making grouping according to the above method, at the time of selecting target icons to be grouped, such icons that correspond respectively to the sight-line detection area in which the sight line exists and the determined other sight-line detection areas may be subject to grouping. Namely, in the case of FIG. 4(b), for example, only the icons 41 to 45 that correspond respectively to the sight-line detection areas 51 to 55 in the combined sight-line detection area may be grouped.

Using at least one of the detailed information of the display objects acquired by the group generator 11 and the recognition result selected by the recognition-result selector 8, the identifier 12 performs narrowing down from the display objects grouped by the group generator 11. Then, it identifies one display object from among the grouped display objects. Alternatively, the identifier, when one display object cannot be identified, outputs a narrowed-down result showing that one display object cannot be identified, and also re-groups the narrowed-down display objects. The identifier outputs, when one display object can be identified, a narrowed-down result showing that fact.

Based on the information acquired from the navigator 1, the recognition dictionary controller 13 outputs an instruction to the speech recognizer 6 for causing it to activate a specified speech recognition dictionary 7.

Specifically, speech recognition dictionaries have been associated beforehand with respective display screens (for example, a map screen, etc.) to be displayed on the display (display device) 3 and respective functions (for example, an address search function, a facility search function, etc.) to be executed by the navigator 1, so that, based on screen information or information about the function under execution that is acquired from the navigator 1, the recognition dictionary controller outputs an instruction to the speech recognizer 6 for causing it to activate the corresponding recognition dictionary.

Further, based on the detailed information of the display objects grouped by the group generator 11 or the display objects re-grouped by the identifier 12, the recognition dictionary controller 13 dynamically generates a speech recognition dictionary for identifying one display object from among the grouped display objects (hereinafter, mentioned as “display-object identification dictionary”). Namely, the recognition dictionary controller dynamically generates a speech recognition dictionary corresponding to the display objects grouped by the group generator 11 or the display objects re-grouped by the identifier 12. Then, it outputs an instruction to the speech recognizer 6 for causing it to activate only the display-object identification dictionary having been dynamically generated.

Further, the recognition dictionary controller 13 outputs an instruction to the speech recognizer 6 for causing it to activate a speech recognition dictionary whose recognition target is a word string, etc. for performing an operation with respect to the one display object identified by the identifier 12 (hereinafter, mentioned as “display-object operation dictionary”).

Here, how to generate the display-object identification dictionary will be described.

In the case where the display objects of different types are being grouped, the recognition dictionary controller 13 generates, using the detailed information of the respective display objects, a speech recognition dictionary that includes words, etc. each for identifying one of these types. Specifically, the dictionary may be that which includes, as a recognition vocabulary, the types themselves such as “parking place”, “gas station” and the like, or may be that which includes paraphrasing terms corresponding to the item names, such as “to park”, “to refuel” and the like, and/or a recognition vocabulary containing intentions such as “want parking”, “want refueling” and the like.

Meanwhile, in the case where the display objects of a same type are grouped, the recognition dictionary controller 13 generates, using the detailed information of the respective display objects, a speech recognition dictionary including words, etc. each for identifying one display object. Specifically, in the case, for example, where plural display objects of a type of “parking place” are being grouped, in order to identify one display object from among the plural display objects (icons) belong to “parking place”, the recognition dictionary controller generates a dictionary including information related to the type “parking place”, such as “emptiness”, “charge” and the like.

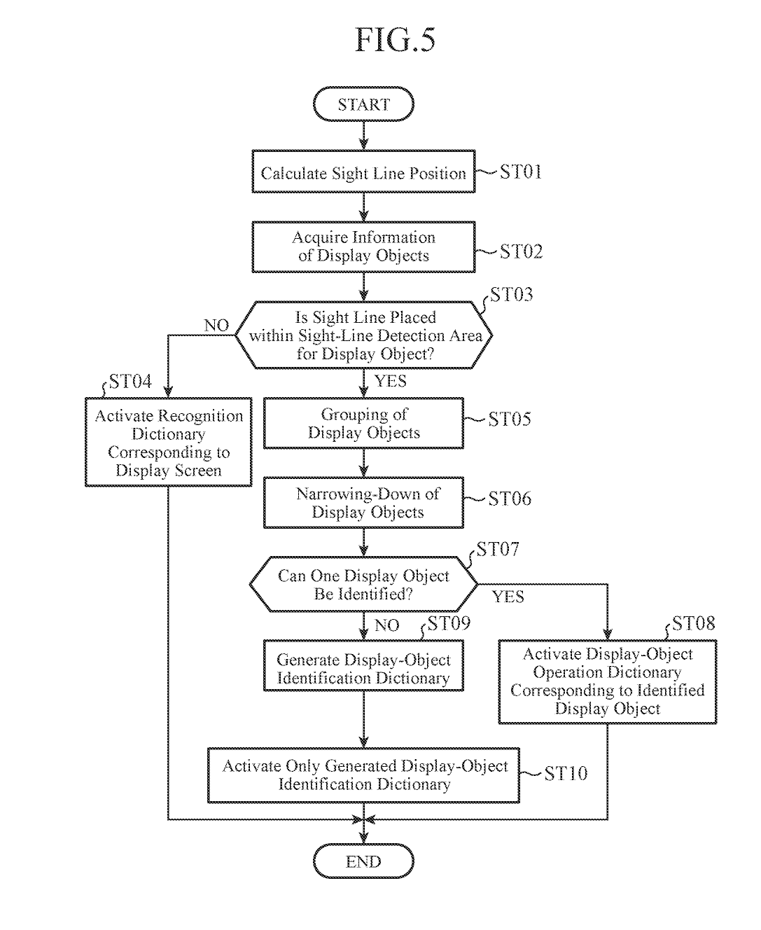

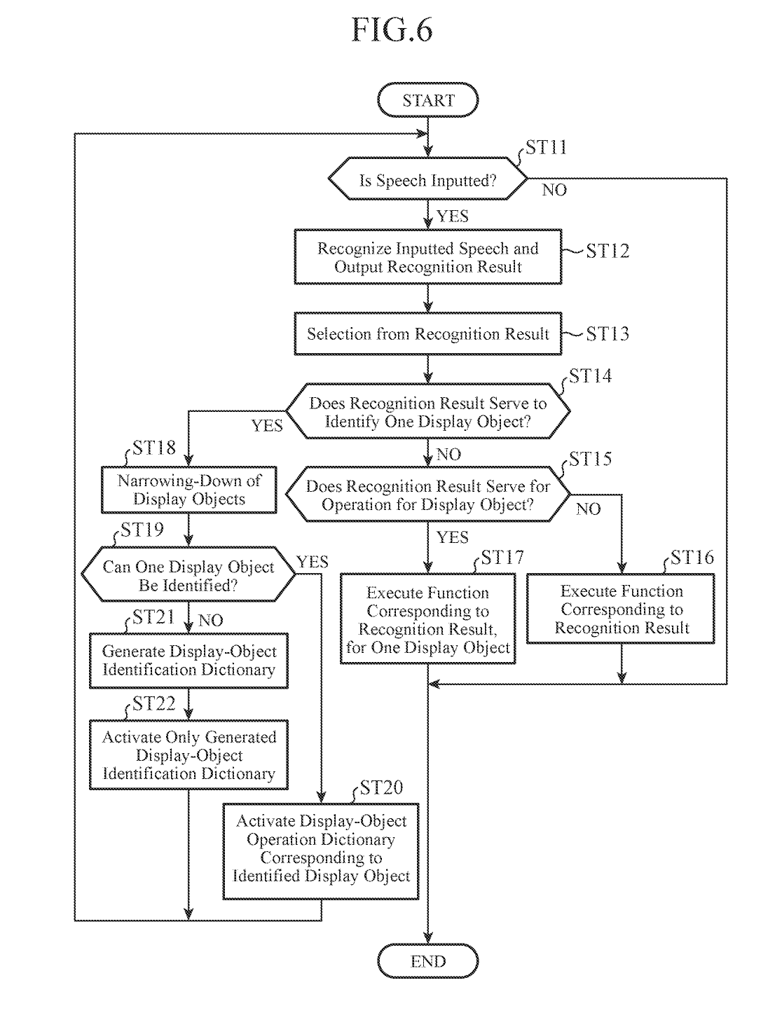

Next, operations of the speech recognition device of Embodiment 1 will be described using flowcharts shown in FIG. 5 and FIG. 6.

FIG. 5 is a flowchart showing processing for grouping the display objects, generating the speech recognition dictionary corresponding to the grouped display objects, and activating the speech recognition dictionary, in Embodiment 1.

Firstly, the sight line detector 10 analyzes the image acquired by the camera 9 to detect the user's sight line directed to the display (display device) 3, and calculates the position of the sight line on the display (display device) 3 (Step ST01).

Then, the group generator 11 acquires position information and detailed information of the display objects displayed on the display (display device) 3 from the navigator 1 (Step ST02).

Thereafter, the group generator 11 sets the sight-line detection area for each of the display objects acquired from the navigator 1 to thereby determine whether or not the sight line exists in any one of the sight-line detection areas (Step ST03).

When the sight line does not exist in any one of the sight-line detection areas (in the case of “NO” in Step ST03), the recognition dictionary controller 13 outputs, for example, an instruction to the speech recognizer 6 for causing it to activate the speech recognition dictionary matched to the screen displayed on the display (display device) 3, so that the speech recognizer 6 activates the dictionary specified by that instruction (Step ST04).

On the other hand, when the sight line exists in any one of the sight-line detection areas (in the case of “YES” in Step ST03), it is assumed that the user wants a speech-based operation with respect to a display object, so that processing in Steps ST05 and later is performed. At that time, firstly, the group generator 11 groups the display objects together by the aforementioned method (Step ST05).

Then, the identifier 12 acquires detailed information of the respective grouped display objects from the group generator 11 to thereby perform narrowing-down from the grouped display objects on the basis of the detailed information, and outputs a narrowed-down result (Step ST06).

Thereafter, the recognition dictionary controller 13 acquires the narrowed-down result and detailed information of the narrowed-down display object from the identifier 12, and when the narrowed-down result shows that one display object can be identified (in the case of “YES” in Step ST07), in order to allow a speech-based operation with respect to the thus-identified display object, the recognition dictionary controller instructs the speech recognizer 6 to activate the display-object operation dictionary corresponding to the thus-identified display object, so that the speech recognizer 6 activates the speech recognition dictionary specified by that instruction (Step ST08).

Meanwhile, when the narrowed-down result does not show that one display object can be identified (in the case of “NO” in Step ST07), in order for the user to be able to efficiently identify one display object, the recognition dictionary controller 13 generates the display-object identification dictionary on the basis of the detailed information of the grouped display objects (Step ST09).

Thereafter, the recognition dictionary controller 13 outputs an instruction to the speech recognizer 6 for causing it to activate only the thus-generated display-object identification dictionary, so that the speech recognizer 6 activates only the display-object identification dictionary specified by that instruction (Step ST10).

The above processing having been mentioned using the flowchart will be described using a specific example. For example, as shown in FIG. 4(a), it is assumed that the icons 41 to 46 are displayed on the display (display device) 3 and the sight line is calculated to be positioned at 60 by the sight line detector 10. Further, it is assumed that the icons 41 to 43 have sets of detailed information shown in FIGS. 3(a), (b) and (c) and the icons 44 and 45 have sets of detailed information shown in FIGS. 3(d) and (e), respectively.

Since the sight line 60 is placed within the sight-line detection area 51 for the icon 41, the group generator 11 determines each of the sight-line detection areas 52 to 55 that is overlapping partly with the sight-line detection area 51, as the other sight-line detection area, and combines the sight-line detection areas 51 to 55 to thereby group the icons 41 to 45 together (Step ST01 to Step ST05).

The identifier 12 acquires the detailed information of FIG. 3(a) to (e) from the group generator 11.

Here, because the content of the item “emptiness” in the detailed information corresponding to the icon 42 is “full” that is indicative of being fully filled with vehicles, the identifier 12 narrows down the display objects into the icons 41 and 43 to 45, followed by re-grouping them. Then, it outputs a narrowed-down result showing that one display object cannot be identified (Step ST06).

Then, according to the narrowed-down result (in the case of “NO” in Step ST07), the recognition dictionary controller 13 generates the display-object identification dictionary (Step ST09).

Specifically, referring to the detailed information of FIG. 3(a) and (c), the icons 41 and 43 are of the type of “parking place”, and referring to the detailed information of FIGS. 3(d) and (e), the icons 44 and 45 are of the type of “gas station”, so that the icons of two different types are being grouped. Thus, the recognition dictionary controller 13 acquires the item names of “parking place” and “gas station” from the detailed information of the respective icons, and generates the display-object identification dictionary including these names as recognition target terms each for identifying one of these types.

Note that paraphrasing terms corresponding to the item names, such as “to park”, “to refuel” and the like, for example, may be used as recognition target terms.

Further, for the grouped icons in which present are a predetermined given number or more (or, more than the given number) of icons, the recognition dictionary controller 13 may cause the display-object identification dictionary to include a recognition target term for hiding these icons or for reducing in size these icons.

For example, when the predetermined given number is “5” and six icons of the type of “gas station” are present in the grouped icons, the recognition dictionary controller 13 generates the display-object identification dictionary that includes a recognition target term such as, for example, “hide gas stations”.

Furthermore, based on the position information on the display (display device) 3 of each of the grouped icons, the recognition dictionary controller 13 may cause the display-object identification dictionary to include a recognition target term for determining a position, such as, “right”, “left icon” or the like, for example. Namely, for example, as shown in FIG. 4(a), in the case where the icons 41 to 45 displayed on the display (display device) 3 are grouped, with the assumption that the user might speak “lower right icon” when he/she wants to select the icon 45, those vocabularies may be included in the display-object identification dictionary.

Thereafter, the recognition dictionary controller 13 instructs the speech recognizer 6 to activate only the generated display-object identification dictionary, so that the speech recognizer 6 activates only the display-object identification dictionary specified by that instruction (Step ST10).

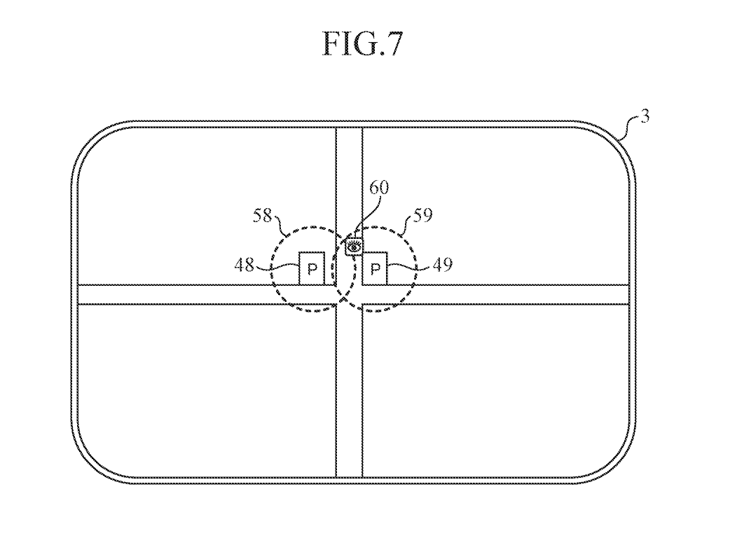

Next, description will be made about the case where, as shown in FIG. 7, icons 48 and 49 are displayed on the display (display device) 3 and the sight line is calculated to be positioned at 60. Further, it is assumed that the icons 48 and 49 have sets of detailed information shown in FIGS. 3(a) and (c), respectively, so that both of them are of the type of “parking place” and have the emptiness of “vacant” and the charge of “600 yen”.

Here, processing in Steps ST01 to ST05 shown in the flowchart of FIG. 5 is similar to that in the case described in the example of FIG. 4, so that its description is omitted.

In this case, the identifier 12 is unable to identify one of the icons on the basis of the detailed information corresponding to the icon 48 and 49 grouped by the group generator 11 and thus, outputs a narrowed-down result showing that fact (Step ST06). According to that narrowed-down result (in the case of “NO” in Step ST07), the recognition dictionary controller 13 generates the display-object identification dictionary (step ST09).

Specifically, referring to FIGS. 3(a) and (c), the recognition dictionary controller 13 finds that the icons 48 and 49 are of the type of “parking place” and thus, icons of the same type are grouped. Thus, the recognition dictionary controller 13 acquires from the detailed information of the icons, the item names of “emptiness” and “charge”, and generates based on these, the display-object identification dictionary including recognition target terms, such as “available”, “low fee” and the like, each for identifying one display object.

Thereafter, the recognition dictionary controller 13 instructs the speech recognizer 6 to activate only the generated display-object identification dictionary, so that the speech recognizer 6 activates only the display-object identification dictionary specified by that instruction (Step ST10).

Lastly, description will be made about the case where as shown in FIG. 2, the icon 40 is displayed on the display (display device) 3 and the sight line is calculated to be positioned at 60.

Because there is no sigh-line detection area overlapping partly with the sight-line detection area 50 in which the sight line 60 exists, the group generator 11 sets the icon 40 corresponding to the sight-line detection area 50 as a group (Step ST01 to Step ST05).

Because the number of grouped icons is one, the identifier 12 outputs a narrowed-down result showing that one icon can be identified (Step ST06). According to that determination (the determination of “YES” in Step ST07), the recognition dictionary controller 13 outputs an instruction to the speech recognizer 6 for causing it to activate the display-object operation dictionary corresponding to the icon 40. Then, the speech recognizer 6 activates the display-object operation dictionary specified by that instruction (Step ST08).

Note that it is assumed that the display-object operation dictionary is prepared beforehand for each of the display objects.

FIG. 6 is a flowchart showing processing for identifying one display object from among the grouped display objects using a speech-based operation, in Embodiment 1.

Firstly, when the speech-recognition-start instruction part is pressed down by the user, the speech recognizer 6 determines whether a speech is inputted or not, and terminates its processing when no speech is inputted for a specific time period (in the case of “NO” in Step ST11).

Meanwhile, when a speech is inputted (in the case of “YES” in Step ST11), the speech recognizer 6 recognizes the inputted speech and outputs a recognition result (Step ST12).

Then, the recognition result selector 8 selects from among the recognition-result character strings outputted from the speech recognizer 6, one having a highest recognition score (Step ST13).

Thereafter, the recognition result selector 8 determines whether or not the selected recognition-result character string is included in the display-object identification dictionary (Step ST14).

Then, when determined that it is not included in the display-object identification dictionary, namely, that the user's speech is not that for identifying one display object (in the case of “NO” in Step ST14), the recognition result selector 8 outputs the recognition result to the navigator 1.

Thereafter, the navigator 1 acquires the recognition result outputted from the recognition result selector 8, and determines whether or not the recognition-result character string is included in the display-object operation dictionary (Step ST15).

Here, when it is determined that it is not included in the display-object operation dictionary, namely, that the user's speech is not that for performing an operation with respect to one display object (in the case of “NO” in Step ST15), the navigator 1 executes a function corresponding to the recognition result (Step ST16).

In contrast, when it is determined that it is included in the display-object operation dictionary, namely, that the user's speech is that for performing an operation with respect to one display object (in the case of “YES” in Step ST15), the navigator 1 executes a function corresponding to the recognition result, with respect to the one display object identified by the identifier 12 (Step ST17).

Meanwhile, in Step ST14, when the recognition result selector 8 determined that the selected recognition-result character string is included in the display-object identification dictionary, namely, that the user's speech is that for identifying one display object (in the case of “YES” in Step ST14), the recognition result selector 8 outputs the selected recognition result to the identifier 12.

Then, the identifier 12 acquires the recognition result outputted by the recognition result selector 8, performs narrowing-down from the grouped display objects, and outputs a narrowed-down result (Step ST18).

The recognition dictionary controller 13 acquires such a determination result and detailed information of the narrowed-down display object from the identifier 12 and, when that determination result shows that one display object can be identified (in the case of “YES” in Step ST19), outputs an instruction to the speech recognizer 6 for causing it to activate the display-object operation dictionary corresponding to the thus-identified display object, so that the speech recognizer 6 activates the display-object operation recognition dictionary specified by that instruction (Step ST20).

In contrast, when the determination result by the identifier 12 does not show that one display object can be identified (in the case of “NO” in Step ST19), the recognition dictionary controller 13 generates a display-object identification dictionary on the basis of the detailed information of the narrowed-down display objects (Step ST21).

Thereafter, the recognition dictionary controller 13 outputs an instruction to the speech recognizer 6 for causing it to activate the thus-generated display-object identification dictionary, so that the speech recognizer 6 activates the speech recognition dictionary specified by that instruction (Step ST22).

The above processing having been mentioned using the flowchart will be described using a specific example.

For example, as shown in FIG. 4(a), it is assumed that the icons 41 to 46 are displayed on the display (display device) 3 and the sight line is calculated to be positioned at 60 by the sight line detector 10. Further, it is assumed that the icons 41 to 43 have sets of detailed information shown in FIGS. 3(a), (b) and (c) and the icons 44 and 45 have sets of detailed information shown in FIGS. 3(d) and (e), respectively.

Here, in the situation as in FIG. 4(a), it is assumed that the icons 41, 42 and 44, 45, for example, are grouped by the processing in the flowchart in FIG. 5 and only the display-object identification dictionary whose recognition target is words, etc. for determining one type, namely “parking place” and “gas station”, is activated.

Firstly, when the user speaks “parking place” according to a system guidance (in the case of “YES” in Step ST11), the speech recognizer 6 performs speech recognition processing and outputs a recognition result (Step ST12).

Here, “parking place” and “gas station” are only the target terms for speech recognition, so that “parking place” is outputted as the recognition result.

The recognition result selector 8 selects the recognition result “parking place” outputted from the speech recognizer 6 (Step ST13). Then, because the selected recognition-result character string is included in the display-object identification dictionary (in the case of “YES” in Step ST14), the recognition result selector 8 outputs the selected recognition result to the identifier 12.

Then, the identifier 12 refers to the detailed information of each of the grouped display objects, to thereby identify the icons 41 and 42 each having the type matched to the recognition-result character string “parking place”, and re-groups them together. Further, it outputs a narrowed-down result showing that one icon cannot be identified (Step ST18).

The recognition dictionary controller 13 acquires the narrowed-down result and the detailed information of the icon 41 and the icon 42 from the identifier 12. Here, the narrowed-down result shows that one icon cannot be identified (in the case of “NO” in Step ST19) and, referring to FIGS. 3(a) and (b), the types of the two icons are the same “parking place”, the recognition dictionary controller acquires the item names of “emptiness” and “charge” from the detailed information of the display objects and, based on these, generates the display-object identification dictionary whose recognition targets are, for example, “available”, “low fee” and the like (Step ST21).

Thereafter, the recognition dictionary controller 13 outputs an instruction to the speech recognizer 6 for causing it to activate only the thus-generated display-object identification dictionary, so that the speech recognizer 6 activates the display-object identification dictionary specified by that instruction (Step ST22).

Subsequently, when in order to identify one display object, the user speaks “emptiness” according to the system guidance (in the case of “YES” in Step ST11), the speech recognizer 6 performs speech recognition processing and outputs a recognition result (Step ST12). Here, “emptiness” and “low fee” are only the recognition target terms, so that “emptiness” is outputted as the recognition result.

The recognition result selector 8 selects the recognition result “emptiness” outputted from the speech recognizer 6 (Step ST13). Then, because the selected recognition-result character string is included in the display-object identification dictionary (in the case of “YES” in Step ST14), the recognition result selector 8 outputs the selected recognition result to the identifier 12.

Then, the identifier 12 refers to the detailed information of the grouped icons 41 and 42 to thereby identify an icon whose emptiness is “vacant”. Here, because the icon whose emptiness is “vacant” is only the icon 41, it outputs a narrowed-down result showing that one display object can be identified (Step ST18).

Then, the recognition dictionary controller 13 acquires such a determination result and the detailed information of the icon 41 from the identifier 12. Then, according to the narrowed-down result (in the case of “YES” in Step ST19), it outputs an instruction to the speech recognizer 6 for causing it to activate the display-object operation dictionary corresponding to the icon 41, so that the speech recognizer 6 activates the display-object operation dictionary specified by that instruction (Step ST20).

As described above, according to Embodiment 1, even in the case where there are many abutting sight-line detection areas or many overlapping portions between sight-line detection areas as exemplified by the case where a plurality of icons (display objects) are congested on the display screen, it is possible to efficiently narrow down using the sight line and the speech-based operation to thereby identify one icon (display object), and further to decrease false recognition, so that the user's convenience can be enhanced.

Note that in Embodiment 1, even when the sight line deviates from the sight-line detection area for the display object or the combined sight-line detection area combined by the group generator 11, it may be intended that the speech recognition dictionary having been activated is kept unchanged, until a predetermined specific period of time elapses. Namely, it may be intended that the recognition dictionary controller 13 keeps activated the dynamically-generated speech recognition dictionary from the time the sight line deviates from the sight-line detection area for the display object or the combined sight-line detection area, until the predetermined specific period of time elapses.

This is because, when an elapsed period of time after the sight line deviates is short, there is a possibility that the user has unintentionally deviated the sight line from the sight-line detection area. Meanwhile, it is thought that the longer the elapsed time period after the sight line deviates, the higher the possibility that the user has intentionally deviated the sight line in order to quit identifying the display object or performing an operation for the display object (in order to perform another operation).

In a specific case of processing, even when the sight line does not exist in the sight-line detection area in which the sight line has been detected or in the combined sight-line detection area combined by the group generator 11 (in the case of “NO” in Step ST03 in FIG. 5), if a predetermined specific period of time does not elapse after grouping the display objects, the group generator 11 may terminate its processing without execution of Step ST04.

Additionally, the above “specific period of time” may be not a predetermined one but such one that is calculated so as to have a positive correlation with a time period during which the sight line has existed in the sight-line detection area for a display object or the combined sight-line detection area. Namely, if the time period during which the sight line has existed in the sight-line detection area for a display object or the combined sight-line detection area is long, it is thought that the user would really want to select that display object, so that “specific period of time” may be made longer accordingly.

Further, in Embodiment 1, the identifier 12 may differentiate a display form, such as a color, a size, of the display objects grouped by the group generator 11, the display objects re-grouped by the identifier 12 or the display object identified by the identifier 12, from that of the other display objects. The same also applies to the following embodiments.

In this case, it suffices that the identifier 12 outputs an order to cause the grouped display objects, the re-grouped display objects or the identified display object, to be displayed in a specific display form, and the navigator 1 outputs an instruction to the display (display device) 3 for causing it to display the display objects according to that order.

Note that the speech recognition device 30 is implemented as a hardware-software cooperated substantial measure in such a manner that a computer of the navigation device to which the speech recognition device is applied, executes a program relevant to processing characteristic of this invention. The same also applied to the following embodiments.

### Embodiment 2

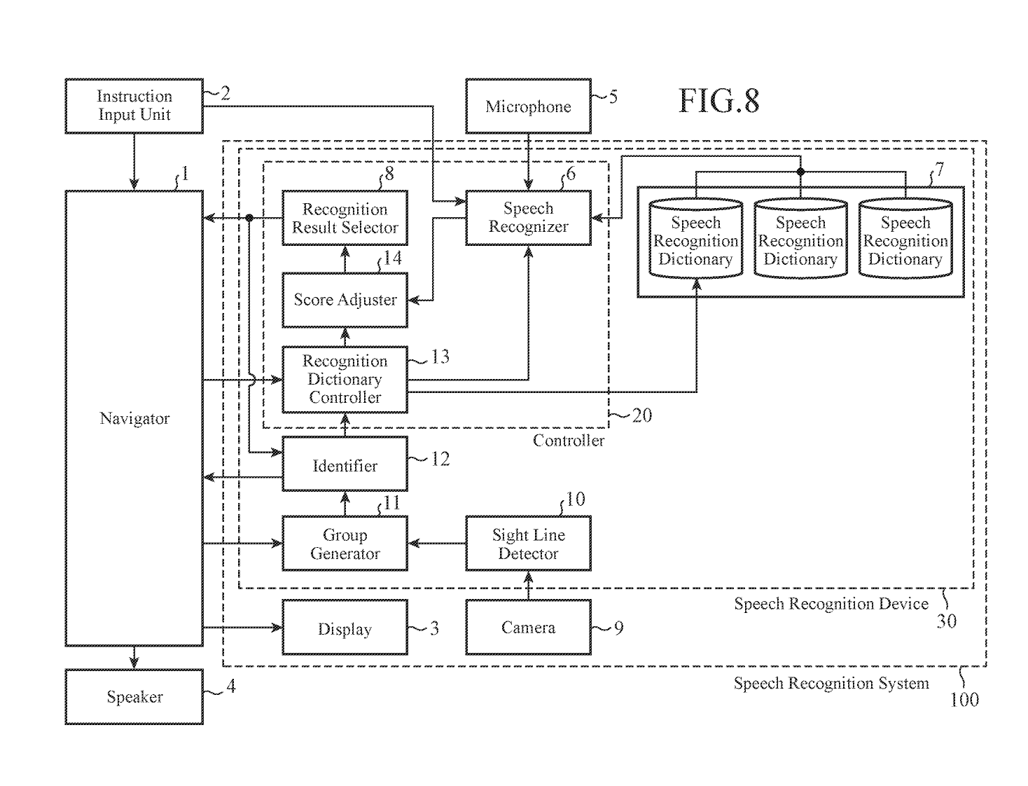

FIG. 8 is a block diagram showing an example of a navigation device to which a speech recognition device and a speech recognition system according to Embodiment 2 of the invention are applied. Note that, with respect to the components equivalent to those described in Embodiment 1, the same reference numerals are given thereto, so that duplicated description thereof is omitted.

As compared with Embodiment 1, Embodiment 2 shown below differs in that it further comprises a score adjuster 14 in the controller 20. Further, it differs in that, after generating the display-object identification dictionary, the recognition dictionary controller 13 outputs the words, etc. (or IDs associated with the words, etc.) included in the generated display-object identification dictionary, to the score adjuster 14.

Furthermore, it differs in that, at the time of activating the display-object identification dictionary, another speech recognition dictionary being activated at that time (for example, a speech recognition dictionary corresponding to the map display screen) is kept activated by the recognition dictionary controller 13.

The score adjuster 14 determines whether or not a recognition-result character string (or an ID associated with the recognition-result character string) outputted by the speech recognizer 6 exists in the words, etc. (or IDs associated with the words, etc.) acquired from the recognition dictionary controller 13. Then, when the recognition-result character string exists in the words, etc. acquired from the recognition dictionary controller 13, the score adjuster increases a recognition score corresponding to that recognition-result character string by a specific amount. Namely, the recognition score of the recognition result that is included in the speech recognition dictionary dynamically generated by the recognition dictionary controller 13 is increased.

Note that in Embodiment 2, description will be made assuming that the recognition score is increased by a specific amount; however, the recognition score may be increased by a specific rate.

Further, the score adjuster 14 may be included in the speech recognizer 6.

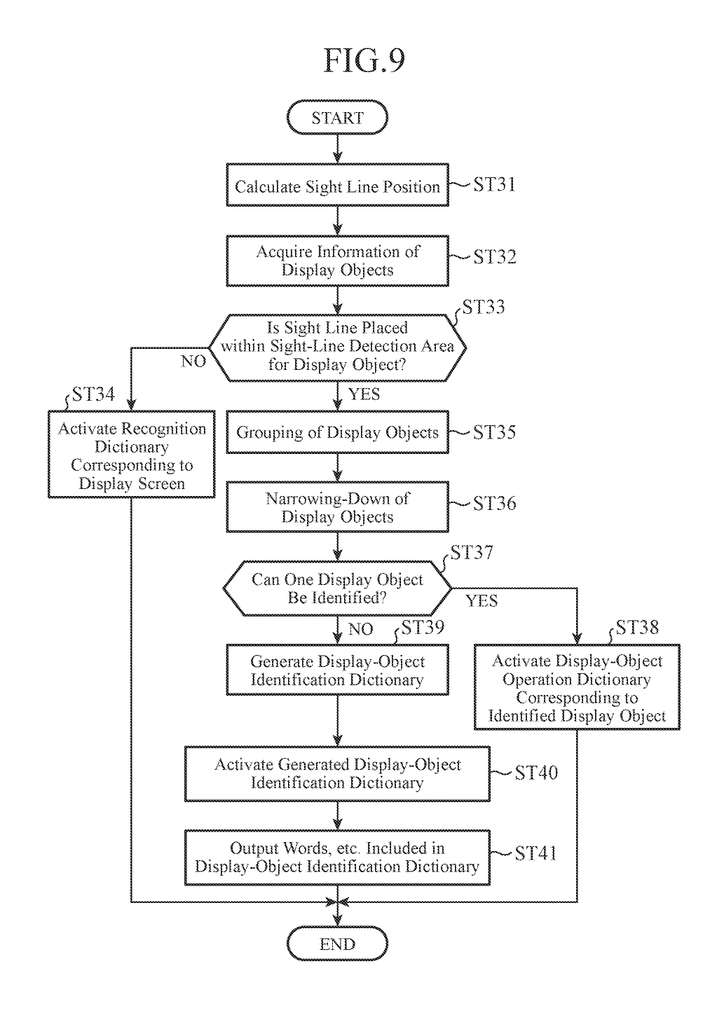

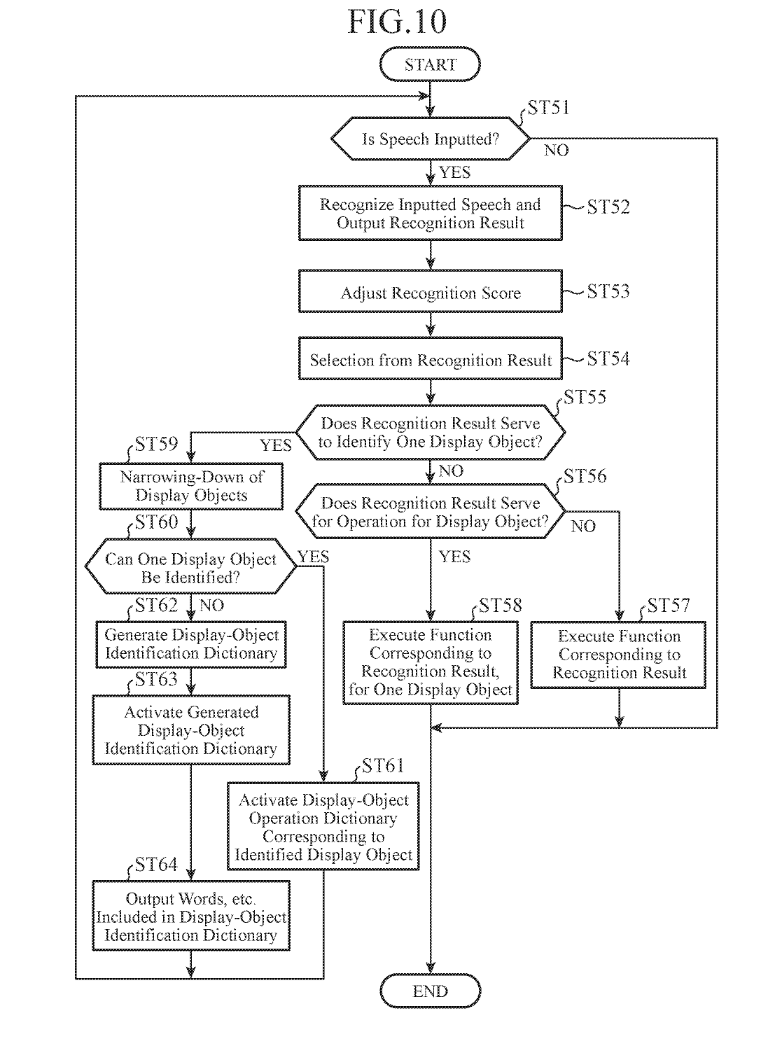

Next, operations of the speech recognition device of Embodiment 2 will be described using flowcharts shown in FIG. 9 and FIG. 10.

FIG. 9 is a flowchart showing processing for grouping the display objects, generating the speech recognition dictionary corresponding to the grouped display objects, and activating the speech recognition dictionary, in Embodiment 2.

In the flowchart shown in FIG. 9, processing in Steps ST31 to ST38 is the same as that in Steps ST01 to ST08 in the flowchart shown in FIG. 5 in Embodiment 1, so that its description is omitted here.

In Step ST37, when the narrowed-down result does not show that one display object can be identified (in the case of “NO” in Step ST37), in order for the user to be able to efficiently identify one display object, the recognition dictionary controller 13 generates a display-object identification dictionary on the basis of the detailed information of the grouped display objects (Step ST39).

Thereafter, the recognition dictionary controller 13 activates the generated display-object identification dictionary; however, it causes not only the display-object identification dictionary to be activated, namely, if another speech recognition dictionary has been activated, without inactivating that, it activates the display-object identification dictionary (Step ST40).

Then, the recognition dictionary controller 13 outputs to the score adjuster 14, the words, etc. (or the IDs associated with the words, etc.) included in the generated display-object identification dictionary (Step ST41).

The above processing having been mentioned using the flowchart will be described specifically using FIG. 4(a), like in Embodiment 1. Here, since processing before Step ST39 is similar to that in Embodiment 1, its detailed description is omitted, so that processing mainly in Steps ST39 to ST41 will be described specifically.

As shown in FIG. 4(a), it is assumed that the icons 41 to 46 are displayed on the display (display device) 3 and the sight line is calculated to be positioned at 60 by the sight line detector 10. Further, it is assumed that the icons 41 to 43 have sets of detailed information shown in FIGS. 3(a), (b) and (c) and the icons 44 and 45 have sets of detailed information shown in FIGS. 3(d) and (e), respectively.

Since the sight line 60 is placed within the sight-line detection area 51 for the icon 41, the group generator 11 determines each of the sight-line detection areas 52 to 55 that is overlapping partly with the sight-line detection area 51, as the other sight-line detection area, and combines the sight-line detection areas 51 to 55 to thereby group the icons 41 to 45 together (Step ST31 to Step ST35).

The identifier 12 acquires the detailed information of FIG. 3(a) to (e) from the group generator 11.

Here, because the content of the item “emptiness” in the detailed information corresponding to the icon 42 is “full” that is indicative of being fully filled with vehicles, the identifier 12 narrows down the display objects into the icons 41 and 43 to 45, followed by re-grouping them. Then, it outputs a narrowed-down result showing that one display object cannot be identified (Step ST36).

Then, according to that narrowed-down result (in the case of “NO” in Step ST37), the recognition dictionary controller 13 acquires the item names of “parking place” and “gas station” from the detailed information of each of the icons, and generates a display-object identification dictionary including these names as recognition target terms for identifying one of these types (Step ST39).

Thereafter, the recognition dictionary controller 13 activates the thus-generated dictionary (Step ST40); however, at that time, even if a speech recognition dictionary for recognizing a facility name, for example, has been activated, the recognition dictionary controller does not inactivate it.

Lastly, the recognition dictionary controller 13 outputs the words “parking place” and “gas station” to the score adjuster 14 (Step ST41).

Note that when paraphrasing terms corresponding to the item names, such as “to park”, “to refuel” and the like are used as recognition target terms, these word strings are also outputted to the score adjuster 14.

FIG. 10 is a flowchart showing processing for identifying one display object from among the grouped display objects using a speech-based operation, in Embodiment 2.

Firstly, when the speech-recognition-start instruction part is pressed down by the user, the speech recognizer 6 determines whether a speech is inputted or not, and terminates its processing when no speech is inputted for a specific time period (in the case of “NO” in Step ST51).

Meanwhile, when a speech is inputted (in the case of “YES” in Step ST51), the speech recognizer 6 recognizes the inputted speech and outputs a recognition result (Step ST52).

Then, the score adjuster 14 determines whether or not each recognition-result character string (or an ID associated with the recognition-result character string) outputted by the speech recognizer 6 exists in the words, etc. (or IDs associated with the words, etc.) acquired from the recognition dictionary controller 13. Then, when the recognition-result character string exists in the words, etc. acquired from the recognition dictionary controller 13, the score adjuster increases the recognition score corresponding to that recognition-result character string, by a specific amount (Step ST53).

Then, the recognition result selector 8 selects from among the recognition-result character strings outputted by the speech recognizer 6, one having a recognition score that is highest after adjustment by the score adjuster 14 (Step ST54).

Note that, here, processing in Steps ST55 to ST62 is the same as that in Steps ST14 to ST21 in the flowchart shown in FIG. 6 in Embodiment 1, so that its description is omitted.

In Step ST62, after generating the display-object identification dictionary, the recognition dictionary controller activates the generated display-object identification dictionary; however, at this time, it causes not only the display-object identification dictionary to be activated, namely, if another speech recognition dictionary has been activated, without inactivating that, it activates the display-object identification dictionary (Step ST63).

Then, the recognition dictionary controller 13 outputs to the score adjuster 14, the words, etc. (or the IDs associated with the words, etc.) included in the generated display-object identification dictionary (Step ST64).

The above processing having been mentioned using the flowchart will be described using a specific example.

Here, in a situation as shown in FIG. 4(a), it is assumed that the icons 41, 42, 44 and 45 are grouped by the processing in the flowchart shown in FIG. 9 and that there are activated: the display-object identification dictionary whose recognition target is words, etc. for identifying one type, namely, “parking place” and “gas station”; and the speech recognition dictionary for recognizing a facility name.

Further, it is assumed that the amount for adjusting the score by the score adjuster 14 is beforehand defined as “+10”.

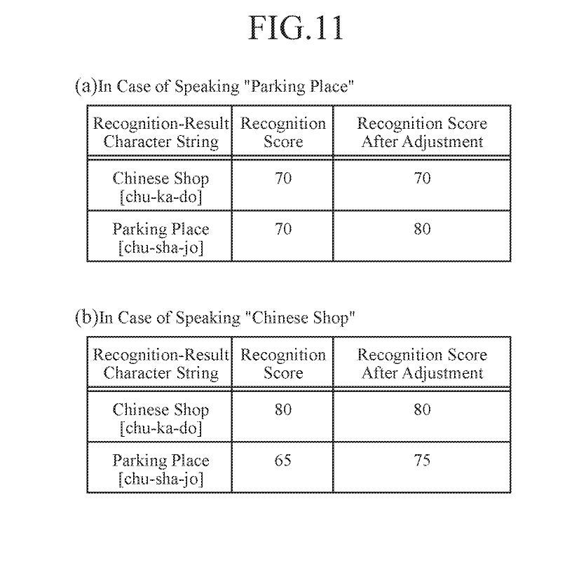

Firstly, when the user speaks “parking place” according to a system guidance (in the case of “YES” in Step ST51), the speech recognizer 6 performs speech recognition processing and outputs a recognition result (Step ST52). Here, it is assumed that, because the display-object identification dictionary and the facility-recognition dictionary have been activated, such a recognition result shown in FIG. 11(a) is outputted from the speech recognizer 6.

FIG. 11 is tables each showing an example of correspondence between a recognition-result character string and a recognition score.

Because the recognition-result character string of “parking place” outputted from the speech recognizer 6 is included in the word strings acquired from the recognition dictionary controller 13 (word strings each consisting of words, etc., included in the display-object identification dictionary), the score adjuster 14 adds “10” to the recognition score corresponding to the recognition-result character string of “parking place” (Step ST53). Namely, as shown in FIG. 11(a), “10” is added to the recognition score “70” of the recognition-result character string of “parking place”, so that the recognition score of “parking place” becomes “80”.

As the result, “parking place” is selected by the recognition result selector 8 (Step ST54), and the display objects are then narrowed down by the subsequent processing. Namely, only because there are activated not only the display-object identification dictionary but also the facility-recognition dictionary, it is unable to identify a recognition result when there is made a speech “parking place” [“chu-sha-jo”, in Japanese pronunciation], since as shown in FIG. 11(a), the recognition score of “parking place [chu-sha-jo]” is the same as that of “Chinese shop” [“chu-ka-do”, in Japanese pronunciation]; however, when the adjustment is applied by the score adjuster 14 as in Embodiment 2, it is possible to obtain a proper recognition result.

Meanwhile, when the user has a sudden desire to search a facility and speaks “Chinese shop [chu-ka-do]” (in the case of “YES” in Step ST51), the speech recognizer 6 performs speech recognition processing and outputs a recognition result (Step ST52). Here, it is assumed that, because the display-object identification dictionary and the facility-recognition dictionary have been activated, such a recognition result shown in FIG. 11(b) is outputted from the speech recognizer 6.

Because the recognition-result character string of “parking place [chu-sha-jo]” outputted from the speech recognizer 6 is included in the word strings acquired from the recognition dictionary controller 13 (word strings each consisting of words, etc., included in the display-object identification dictionary), the score adjuster 14 adds “10” to the recognition score corresponding to the recognition-result character string of “parking place [chu-sha-jo]” (Step ST53). Namely, as shown in FIG. 11(b), “10” is added to the recognition score “65” of the recognition-result character string of “parking place [chu-sha-jo]”, so that the recognition score of “parking place” becomes “75”.

In this case, even if “10” is added to the recognition score of “parking place [chu-sha-jo]” as described above, as compared with such a recognition score after adjustment, the score of “chu-ka-do” is larger, so that “chu-ka-do” is selected by the recognition result selector 8 (Step ST54), and a function corresponding to the recognition result of “Chinese shop [chu-ka-do]” is executed by the subsequent processing (Steps ST55 to ST57). Namely, under such a case, in Embodiment 1, because only the display-object identification dictionary is activated, “Chinese shop [chu-ka-do]” cannot be recognized, so that “parking place [chu-sha-jo]” is falsely recognized by the speech recognizer 6, and as the result, narrowing-down processing to the display object not intended by the user is performed; whereas, according to Embodiment 2, the facility recognition dictionary is activated, so that, unlike the case of Embodiment 1, there is a possibility that “Chinese shop [chu-ka-do]” will be selected by the recognition result selector 8, so that false recognition can be reduced.

As described above, according to Embodiment 2, in addition to providing an effect similar to in Embodiment 1, it is possible to make it easier to recognize a speech for identifying one icon (display object) and further, to increase the user's flexibility to speak.

Note that in Embodiment 2, even if the sight line deviates from the sight-line detection area for the display object or the combined sight-line detection area combined by the group generator 11, it is allowable to keep adjusting the recognition score until a predetermined specific period of time elapses. Namely, it may be intended that the score adjuster 14 keeps increased the recognition score of the recognition result included in the dynamically-generated speech recognition dictionary from the time the sight line deviates from the sight-line detection area for the display object or the combined sight-line detection area until the predetermined specific period of time elapses.

This is because, when an elapsed period of time after the sight line deviates is short, there is a possibility that the user has unintentionally deviated the sight line from the sight-line detection area. Meanwhile, it is thought that the longer the elapsed time period after the sight line deviates, the higher the possibility that the user has intentionally deviated the sight line in order to quit identifying the display object or performing an operation for the display object (in order to perform another operation).

In a specific case of processing, even when the sight line does not exist in the sight-line detection area in which the sight line has been detected or in the combined sight-line detection area combined by the group generator 11 (in the case of “NO” in Step ST33 in FIG. 9), if a predetermined specific period of time does not elapse after grouping the display objects, the group generator 11 may terminate its processing without execution of Step ST34.

Additionally, “specific period of time” may be not a predetermined one but such one that is calculated by the group generator 11, after measuring a time period during which the sight line has existed in the sight-line detection area for a display object or the combined sight-line detection area, so as to have a positive correlation with the thus-measured time period. Namely, if the time period during which the sight line has existed in the sight-line detection area for a display object or the combined sight-line detection area is long, it is thought that the user would really want to select that display object, so that “specific period of time” may be made longer accordingly.

Further, the score adjuster 14 may vary the increased amount for the recognition score so as to have a negative correlation with an elapsed period of time after the sight line deviates from the sight-line detection area or the combined sight-line detection area. Namely, when the elapsed time period after the sight line deviates from the sight-line detection area or the combined sight-line detection area is short, the increased amount for the recognition score is made larger, whereas, the elapsed time period after the sight line deviates is long, the increased amount for the recognition score is made smaller.

This is also because, when the elapsed period of time after the sight line deviates is short, there is a possibility that the user has unintentionally deviated the sight line from the sight-line detection area. Meanwhile, it is thought that the longer the elapsed time period after the sight line deviates, the higher the possibility that the user has intentionally deviated the sight line in order to quit identifying the display object or performing an operation for the display object (in order to perform another operation).

### Embodiment 3

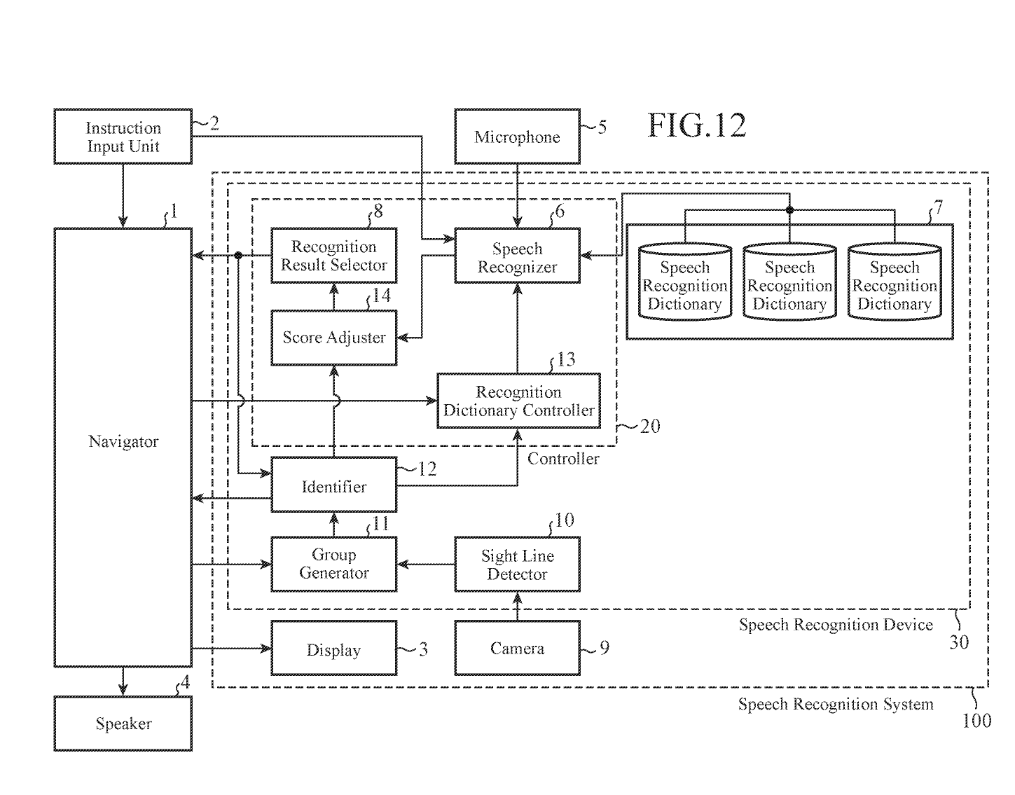

FIG. 12 is a block diagram showing an example of a navigation device to which a speech recognition device and a speech recognition system according to Embodiment 3 of the invention are applied. Note that, with respect to the components equivalent to those described in Embodiments 1 and 2, the same reference numerals are given thereto, so that duplicated description thereof is omitted.

As compared with Embodiment 2, Embodiment 3 shown below differs in that, instead of generating the display-object identification dictionary, the display-object identification dictionary prepared beforehand, has been included in the speech recognition dictionary 7. Further, it differs in that, in place of generating the display-object identification dictionary when the determination result acquired from the identifier 12 does not show that one display object can be identified, the recognition dictionary controller 13 activates the display-object identification dictionary prepared beforehand.

Furthermore, the score adjuster 14 acquires the determination result and the detailed information of the narrowed-down display object from the identifier 12 and, when the determination result does not show that one display object can be identified, generates a list of words, etc. for identifying a display object, on the basis of the detailed information of the display objects. Then, the score adjuster determines whether or not the recognition-result character string outputted from the speech recognizer 6 exists in that list and, when it exists, increases the recognition score corresponding to that recognition-result character string by a specific amount.

Namely, the score adjuster 14 in Embodiment 3 increases the recognition score of the recognition result outputted by the speech recognizer 6 by a specific amount, when the speech recognizer 6 recognizes the recognition target vocabulary relevant to the display objects grouped by the group generator 11 or the display objects re-grouped by the identifier 12.

Note that in Embodiment 3, description will be made assuming that the recognition score is increased by a specific amount; however, the recognition score may be increased by a specific rate.

Further, the score adjuster 14 may be included in the speech recognizer 6.

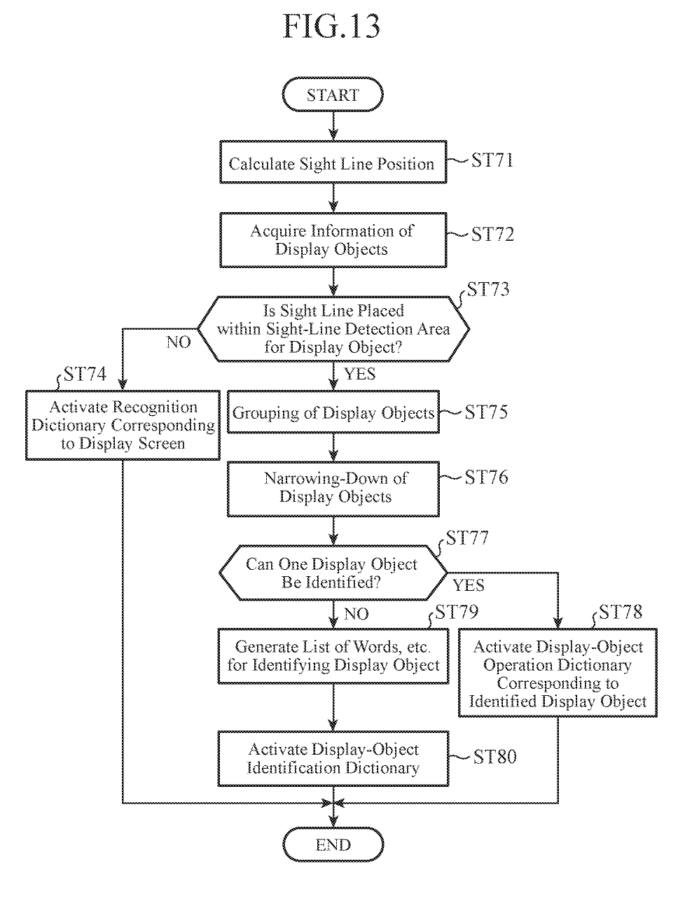

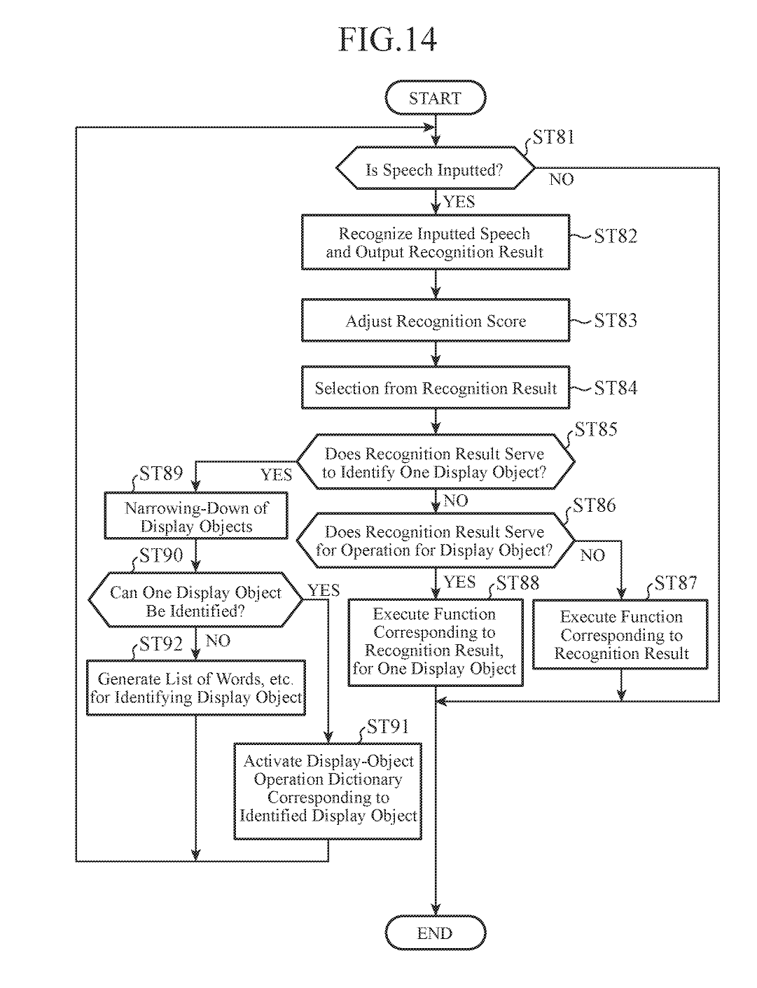

Next, operations of the speech recognition device of Embodiment 3 will be described using flowcharts shown in FIG. 13 and FIG. 14.

FIG. 13 is a flowchart showing processing for grouping the display objects, generating the speech recognition dictionary corresponding to the grouped display objects, and activating the speech recognition dictionary, in Embodiment 3.

In the flowchart shown in FIG. 13, processing in Steps ST71 to ST75 is the same as that in Steps ST01 to ST05 in the flowchart shown in FIG. 5 in Embodiment 1 (in Steps ST31 to ST35 in the flowchart shown in FIG. 9 in Embodiment 2), so that its description is omitted here.

After the group generator 11 groups the icons together in Step ST75, the identifier 12 acquires the detailed information of each of the grouped display objects from the identifier 11, performs narrowing-down from the grouped display objects on the basis of the detailed information and outputs a narrowed-down result (Step ST76).

Then, the recognition dictionary controller 13 acquires that narrowed-down result from the identifier 12. Further, the score adjuster 14 acquires that narrowed-down result and the detailed information of the narrowed-down display object from the identifier 12.

When the narrowed-down result shows that one display object can be identified (in the case of “YES” in Step ST77), the recognition dictionary controller 13 instructs the speech recognizer 6 to activate the display-object operation dictionary corresponding to the thus-identified display object, so that the speech recognizer 6 activates the dictionary specified by that instruction (Step ST78). In contrast, the score adjuster 14 doesn't do anything.

Meanwhile, when the narrowed-down result does not show that one display object can be identified (in the case of “NO” in Step ST77), the score adjuster 14 generates a list of words, etc. for identifying a display object, on the basis of the detailed information of the display objects (Step ST79), and the recognition dictionary controller 13 instructs the speech recognizer 6 to activate the display-object identification dictionary, so that the speech recognizer 6 activates the dictionary specified by that instruction (Step ST80).

FIG. 14 is a flowchart showing processing for identifying one display object from among the grouped display objects using a speech-based operation, in Embodiment 3.

Firstly, when the speech-recognition-start instruction part is pressed down by the user, the speech recognizer 6 determines whether a speech is inputted or not, and terminates its processing when no speech is inputted for a specific time period (in the case of “NO” in Step ST81).

Meanwhile, when a speech is inputted (in the case of “YES” in Step ST81), the speech recognizer 6 recognizes the inputted speech and outputs a recognition result (Step ST82).

Then, the score adjuster 14 determines whether or not each recognition-result character string outputted by the speech recognizer 6 exists in the list of the words, etc. for identifying a display object. Then, when the recognition-result character string exists in the list, the score adjuster increases the recognition score corresponding to the recognition-result character string, by a specific amount (Step ST83).

Then, the recognition result selector 8 selects from among the recognition-result character strings outputted by the speech recognizer 6, one having a recognition score that is highest after adjustment by the score adjuster 14 (Step ST84).

Note that, processing in Steps ST85 to ST89 is the same as that in Steps ST15 to ST18 in the flowchart shown in FIG. 6 in Embodiment 1 (in Steps ST55 to ST59 in the flowchart shown in FIG. 10 in Embodiment 2) so that its description is omitted here.

The identifier 12 acquires detailed information of each of the display objects grouped by the group generator 11 to thereby perform narrowing-down from the grouped display objects on the basis of the detailed information, and outputs a narrowed-down result (Step ST89).

Then, the recognition dictionary controller 13 acquires such a determination result from the identifier 12. Further, the score adjuster 14 acquires such a determination result and the detailed information of the narrowed-down display object from the identifier 12.

When the determination result shows that one display object can be identified (in the case of “YES” in Step ST90), the recognition dictionary controller 13 outputs an instruction to the speech recognizer 6 for causing it to activate the display-object operation dictionary corresponding to the thus-identified display object, so that the speech recognizer 6 activates the display-object operation dictionary specified by that instruction (Step ST91).

Meanwhile, when the determination result does not show that one display object can be identified (in the case of “NO” in Step ST90), the score adjuster 14 generates the list of words, etc. for identifying a display object, on the basis of the detailed information of the display objects (Step ST92). In contrast, the recognition dictionary controller 13 doesn't do anything.

Note that in Embodiment 3, the description has been made assuming that each speech recognition dictionary prepared beforehand is activated if needed, namely, for example, the facility-name recognition dictionary, the command dictionary, the display-object identification dictionary, the display-object operation dictionary and the like, are each activated if needed; however, only the necessary terms in each of the speech recognition dictionary may be activated.

As described above, according to Embodiment 3, in addition to providing an effect similar to in Embodiment 1, it is possible to make it easier to recognize a speech for identifying one icon (display object) and further, to increase the user's flexibility to speak.

Note that also in Embodiment 3, even if the sight line deviates from the sight-line detection area for the display object or the combined sight-line detection area combined by the group generator 11, it is allowable to keep adjusting the recognition score until a predetermined specific period of time elapses. Namely, it may be intended that the score adjuster 14 keeps increased the recognition score of the recognition result included in the dynamically generated speech recognition dictionary from the time the sight line deviates from the sight-line detection area for the display object or the combined sight-line detection area until the predetermined specific period of time elapses.

Specifically, even when the sight line does not exist in the sight-line detection area in which the sight line has been detected or in the combined sight-line detection area combined by the group generator 11 (in the case of “NO” in Step ST63 in FIG. 13), if a predetermined specific period of time does not elapse after grouping the display objects, the group generator 11 may terminate its processing without execution of Step ST64.

Additionally, “specific period of time” may be not a predetermined one but such one that is calculated by the group generator 11, after measuring a time period during which the sight line existed in the sight-line detection area for a display object or the combined sight-line detection area, so as to have a positive correlation with the thus-measured time period. Namely, if the time period during which the sight line existed in the sight-line detection area for a display object or the combined sight-line detection area is long, it is thought that the user would really want to select that display object, so that “specific period of time” may be made longer accordingly.

Further, the score adjuster 14 may vary the increased amount for the recognition score so as to have a negative correlation with an elapsed period of time after the sight line deviates from the sight-line detection area or the combined sight-line detection area. Namely, when the elapsed time period after the sight line deviates from the sight-line detection area or the combined sight-line detection area is short, the increased amount for the recognition score is made larger, whereas, the elapsed time period after the sight line deviates is long, the increased amount for the recognition score is made smaller.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

The speech recognition device of the invention may be applied to a navigation device or navigation system to be installed in a moving object, such as a vehicle, and additionally, to any type of device or system if it is such a device or system that allows selecting a display object displayed on a display, etc. to thereby give an instruction for operation.

### DESCRIPTION OF REFERENCE NUMERALS AND SIGNS

1: navigator, 2: instruction input unit, 3: display (display device), 4: speaker, 5: microphone, 6: speech recognizer, 7: speech recognition dictionary, 8: recognition result selector, 9: camera, 10: sight line detector, 11: group generator, 12: identifier, 13: recognition dictionary controller, 14: score adjuster, 20 controller, 30: speech recognition device, 40 to 49: display object (icon), 50 to 59: sight-line detection area, 60: sight line, 100: speech recognition system.

1. A speech recognition device which recognizes a speech spoken by a user to thereby identify from among a plurality of display objects displayed on a display device, one display object that corresponds to a recognition result, said speech recognition device comprising:
a controller to acquire the speech spoken by the user, thereby to recognize the acquired speech with reference to a speech recognition dictionary, and to output the recognition result;
a sight line detector to detect a sight line of the user;
a group generator to combine sight-line detection areas defined respectively for the display objects, on the basis of a sight-line detection result detected by the sight line detector, to thereby group together the display objects existing within a combined sight-line detection area having been combined; and
an identifier to perform narrowing-down from the display objects grouped by the group generator, on the basis of the recognition result outputted by the controller;
wherein the identifier identifies one display object from among the grouped display objects, or, when the one display object cannot be identified, re-groups the narrowed-down display objects.

2. The speech recognition device of claim 1, wherein the controller dynamically generates the speech recognition dictionary that corresponds to the display objects grouped by the group generator or the display objects re-grouped by the identifier.

3. The speech recognition device of claim 2, wherein the speech recognition dictionary includes a recognition target term for identifying one display object from among the display objects grouped by the group generator or the display objects re-grouped by the identifier.

4. The speech recognition device of claim 3, wherein, in the case where the display objects are present as being of plural types, the speech recognition dictionary includes recognition target terms for identifying the types of the display objects.

5. The speech recognition device of claim 3, wherein, in the case where the display objects are present in a plural number but as being of a single type, the speech recognition dictionary includes a recognition target term for identifying one display object.

6. The speech recognition device of claim 3, wherein, in the case where a number of the display objects grouped by the group generator or the display objects re-grouped by the identifier is equal to or more than a predetermined number, the speech recognition dictionary includes a recognition target term for deleting the display object equal to or more than that predetermined number.

7. The speech recognition device of claim 2, wherein the controller activates only the dynamically-generated speech recognition dictionary.

8. The speech recognition device of claim 2, wherein the controller increases a recognition score of the recognition result that is included in the dynamically-generated speech recognition dictionary.

9. The speech recognition device of claim 2, wherein the controller keeps activated the dynamically-generated speech recognition dictionary from a time the sight line deviates from the sight-line detection area or the combined sight-line detection area, until a predetermined specific period of time elapses.

10. The speech recognition device of claim 9, wherein the specific period of time has a positive correlation with a time period during which the sight line existed in the sight-line detection area or the combined sight-line detection area.

11. The speech recognition device of claim 2, wherein the controller increases a recognition score of the recognition result included in the dynamically-generated speech recognition dictionary, from a time the sight line deviates from the sight-line detection area or the combined sight-line detection area, until a predetermined specific period of time elapses.

12. The speech recognition device of claim 11, wherein the specific period of time has a positive correlation with a time period during which the sight line existed in the sight-line detection area or the combined sight-line detection area.

13. The speech recognition device of claim 11, wherein an increased amount for the recognition score has a negative correlation with an elapsed time period after the sight line deviates from the sight-line detection area or the combined sight-line detection area.

14. The speech recognition device of claim 1, wherein the controller, when a recognition target vocabulary relevant to the display objects grouped by the group generator or the display objects re-grouped by the identifier is recognized, increases a recognition score of the outputted recognition result.

15. The speech recognition device of claim 14, wherein the controller increases the recognition score of the recognition result included in a dynamically-generated speech recognition dictionary from a time the sight line deviates from the sight-line detection area or the combined sight-line detection area, until a predetermined specific period of time elapses.

16. The speech recognition device of claim 15, wherein the specific period of time has a positive correlation with a time period during which the sight line has existed in the sight-line detection area or the combined sight-line detection area.

17. The speech recognition device of claim 15, wherein an increased amount for the recognition score has a negative correlation with an elapsed time period after the sight line deviates from the sight-line detection area or the combined sight-line detection area.

18. The speech recognition device of claim 1, wherein the identifier varies a display form of the display objects grouped by the group generator, the display objects re-grouped by the identifier, or the display object identified by the identifier.

19. A speech recognition system which comprises:
a display device on which a plurality of display objects are displayed;
a camera that captures to acquire an eye image of a user; and
a speech recognition device which recognizes a speech spoken by the user to thereby identify from among the plurality of display objects displayed on the display device, one display object that corresponds to a recognition result,
said speech recognition device comprising:
a controller to acquire the speech spoken by the user, thereby to recognize the acquired speech with reference to a speech recognition dictionary, and to output the recognition result;
a sight line detector to detect a sight line of the user from the image acquired by the camera;
a group generator to combine sight-line detection areas defined respectively for the display objects, on the basis of a sight-line detection result detected by the sight line detector, to thereby group together the display objects existing within a combined sight-line detection area having been combined; and
an identifier to perform narrowing-down from the display objects grouped by the group generator, on the basis of the recognition result outputted by the controller;
wherein the identifier identifies one display object from among the grouped display objects, or, when the one display object cannot be identified, re-groups the narrowed-down display objects.

20. A speech recognition method in which a speech recognition device recognizes a speech spoken by a user to thereby identify from among a plurality of display objects displayed on a display device, one display object that corresponds to a recognition result,
said speech recognition method comprising:
in a controller, acquiring the speech spoken by the user, thereby to recognize the acquired speech with reference to a speech recognition dictionary, and to output the recognition result;
in a sight line detector, detecting a sight line of the user;
in a group generator, combining sight-line detection areas defined respectively for the display objects, on the basis of a sight-line detection result detected by the sight line detector, to thereby group together the display objects existing within a combined sight-line detection area having been combined; and
in an identifier, performing narrowing-down from the display objects grouped by the group generator, on the basis of the recognition result outputted by the controller, to thereby identify one display object from among the grouped display objects, or, when the one display object cannot be identified, re-grouping the narrowed-down display objects.
